(19) United States
(12) Patent Application Publication
(10) Pub. No.: US 2013/0126009 A1
(43) Pub. Date: May 23, 2013

(54) SYSTEM FOR CLEANING BEER LINES AND RECOVERING DRAFT BEER

(71) Applicants: Tracey M. Killarney, Kalamazoo, MI (US); Lawrence A. Kent, Kalamazoo, MI (US)

(72) Inventors: Tracey M. Killarney, Kalamazoo, MI (US); Lawrence A. Kent, Kalamazoo, MI (US)

(21) Appl. No.: 13/471,771

(22) Filed: May 15, 2012

Related U.S. Application Data
(60) Provisional application No. 61/501,374, filed on Jun. 27, 2011.

(51) Int. Cl. F16K 51/00

(52) U.S. Cl. CPC F16K 51/00
USPC 137/315.01

(57) ABSTRACT

A beer recovery system which uses CO₂ to blow unused beer backwards through the beer lines and back into a beer keg is disclosed.

### CROSS REFERENCE TO RELATED APPLICATIONS

This application asserts priority from provisional application 61/501,374 filed on Jun. 27, 2011, which is incorporated herein by reference.

### FIELD OF THE INVENTION

This invention relates to an apparatus and a method for recovering potentially wasted draft beer prior to cleaning beer lines. Using the inventive apparatus and process, beer which is contained in the lines at the beginning of the cleaning process is recovered instead of being discarded.

### BACKGROUND OF THE INVENTION

Beer lines are tubes used to connect beer kegs to the taps at the bar where the beer is dispensed. These beer lines develop deposits of various sorts over time which can affect the flavor of the beer dispensed at the tap. In order to assure proper flavor, beer lines should be cleaned regularly sometimes as frequently as once every week or two. To do this cleaning the beer lines must be disconnected from the keg and a cleaning solution has to be run through the lines. The lines are then flushed with water to remove the cleaning solution from the lines. Various types of pumps and valves are available to pump and control the flow of the cleaning solution and the rinse water. US patent publication 2007/0204884 relates to an apparatus which creates a pulsed flow in the beer lines to help dislodge sediment. U.S. Pat. No. 5,343,907 relates to a system of solenoid valves which can be used to control the cleaning solution and the water flush.

The known methods all discard the beer which is in the lines when the cleaning process begins. The loss of beer is roughly 0.5 fluid ounces per foot of beer line depending on the inner diameter of the beer line installed. In commercial establishments beer lines can be quite long since the keg cooler may be located some distance from the tap at the bar. This is especially true at large bars offering many kinds of beer on tap and multiple tap locations, necessitating large keg coolers which must be located some distance from the bar. Longer beer lines are larger in diameter to decrease flow resistance, therefore the loss of beer per foot of line is greater. Such bars can lose several hundred dollars in lost beer sales every time the lines are cleaned. Accordingly, there is a need for a device and method of cleaning beer lines which recovers the beer in the lines prior to cleaning them.

### SUMMARY OF THE INVENTION

The present invention provides an apparatus and process for recovering draft beer from dispensing lines prior to industry standard line cleaning methods. One advantage of the invention is that it allows the recovery of usable beer that is otherwise wasted. The process may be used with little disruption to current industry standard line cleaning methods and does not affect the efficacy of these methods.

### BRIEF DESCRIPTION OF THE DRAWINGS

FIG. 1 shows an overview of the present invention;

FIG. 2 shows the draft line recovery lever coupler of the present invention;

FIG. 3 shows the air hose apparatus used with the draft line recovery coupler;

FIG. 4 shows another embodiment of the present invention, allowing for both dispensing and recovery;

FIG. 5 shows another embodiment of the present invention, shown as a retro-fit to existing lever couplers;

FIG. 6 shows a view of an embodiment in which beer is recovered from multiple lines at once.

### DETAILED DESCRIPTION OF THE INVENTION

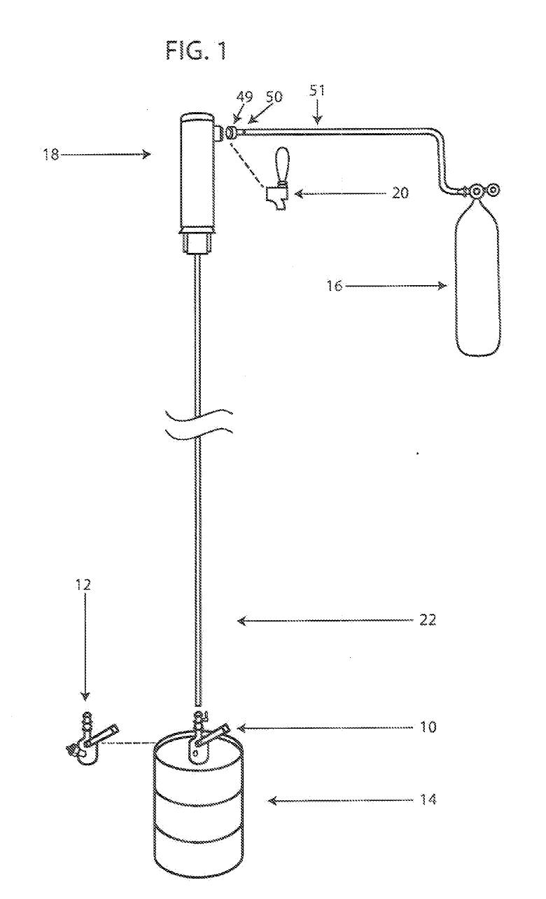

FIG. 1 shows a gas tank 16, a draft tower 18, a faucet 20, a gas line 51 with a faucet coupler 49, a clamp 50, a beer line 22, an establishment's existing keg lever coupler 12, the inventive coupler 10, and a keg 14. Optionally, the faucet coupler 49 may be a quick connect coupler instead of a screw connect coupler. The gas used in the tank may be any gas which is inert to beer, such as helium, argon, carbon dioxide, or nitrogen. Only food grade gasses should be used in order to avoid contamination of the beer lines. Carbon dioxide is the most commonly used gas. The faucet 20 is removed, and the gas line 51 is attached in its place. The standard lever coupler 12, which is normally used, is replaced by the inventive lever coupler 10. The beer line 22 is removed from the standard lever coupler 12 to the inventive lever coupler 10.

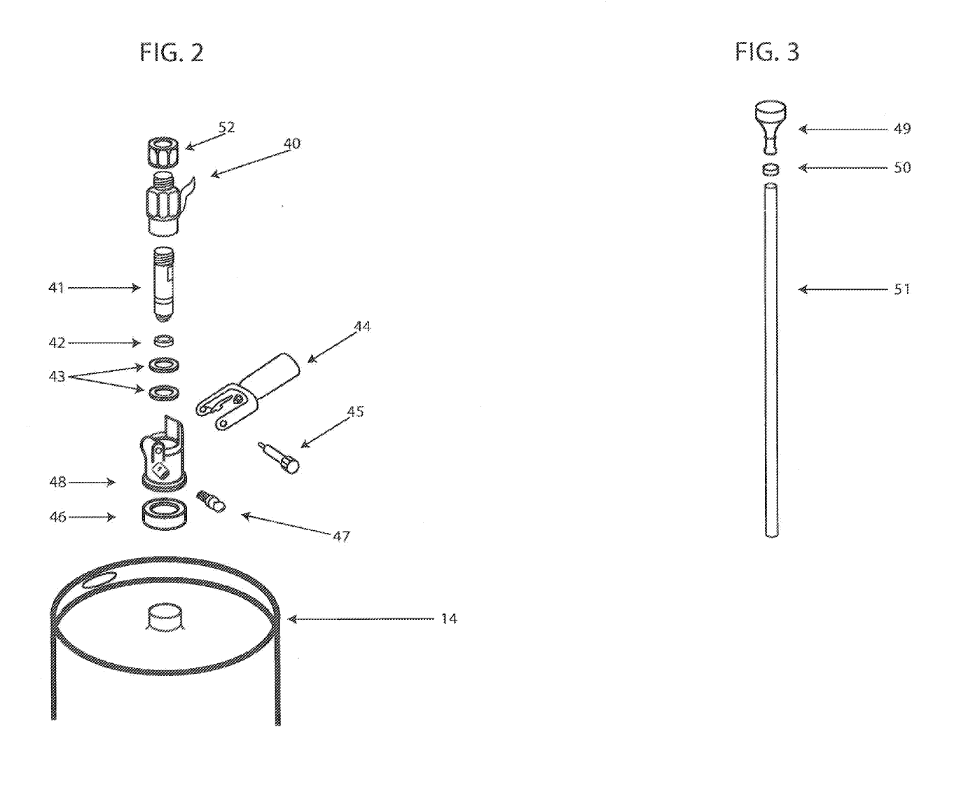

FIG. 2 shows the components of lever coupler 10 attachable to a keg 14, a shut off valve 40, a probe 41, a seal 42, o-rings 43, a lever 44, a lever securing pin 45, a washer 46, a pressure relief valve 47, and the body of coupler 48. Optionally, the pressure relief valve 47 may allow for manual or automatic pressure release valve to avoid over pressurizing the keg. The lever coupler 10 does not have a back flow prevention device (check valve) at the beer inlet/outlet side of the coupler 10 in the probe 41, which is typically found in a standard lever coupler for beer kegs, so that when pressure is released from the keg, using pressure relief valve 47, the gas pressure from the gas tank allows for the beer from beer line to flow back into the keg. The lever coupler 10 does not have a gas inlet port on the body of the coupler, which is typically found in a standard lever coupler for a beer keg. Optionally, a connector containing a screen or filter assembly 52 may be placed between shut off valve 40 and beer line 22 shown in FIG. 1.

FIG. 3 shows a gas line 51 having clamp 50 which clamps it to a faucet coupler 49 which is attachable to a standard shank in an establishment's draft tower. Optionally, the faucet coupler 49 may be a quick connect coupler instead of a screw connect coupler.

The gas line 51 may be of varying materials as to accommodate food grade CO2, and lengths as needed to accommodate the expected distance from the standard shank in the establishment's draft tower to a standard food grade CO2 tank. A five foot, 5/16″ ID, food grade gas line 51 is generally sufficient for the embodiments of this invention. However longer or shorter lengths may be used as necessary in the particular environment.

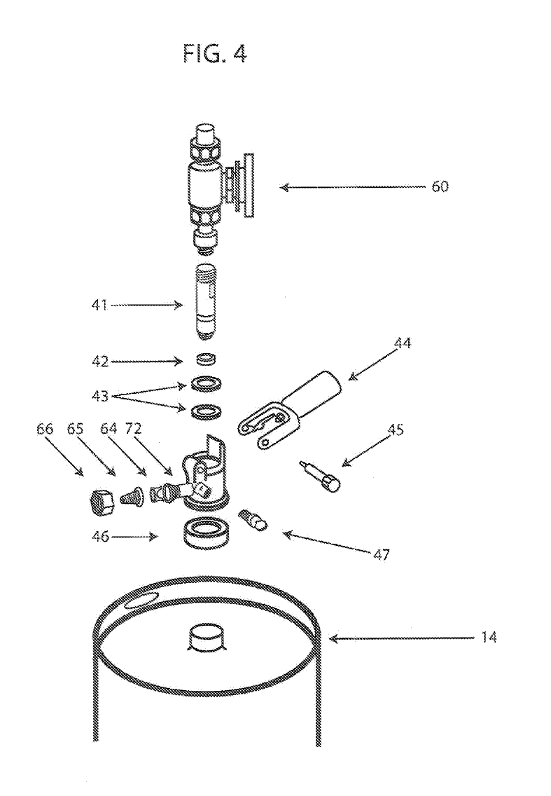

FIG. 4 shows a lever coupler which may be permanently placed on the keg 14. This coupler allows for cleaning, recovery and dispensing to be done by the same coupler, eliminating the need to swap couplers for the cleaning and recovery process. This embodiment found in FIG. 4, is similar to the invention in FIG. 2, and as such includes a shut off valve 40, a probe 41, a seal 42, o-rings 43, a lever 44, a lever securing pin 45, a washer 46, a pressure relief valve 47, and the body of the coupler 48. Optionally, the pressure relief valve 47 may allow for manual or automatic pressure release to avoid over pressurizing the keg. The probe 41 does not have a back flow prevention device at the beer inlet/outlet side of the coupler, which is typically found in a standard lever coupler for kegs 14. However, in addition it has a gas inlet port 72, including a check valve 64, a hose nipple 65 and a hex nut 66. Further this embodiment includes a two-way valve with a lock out mechanism 60 used for the prevention of back flow during normal dispensing mode.

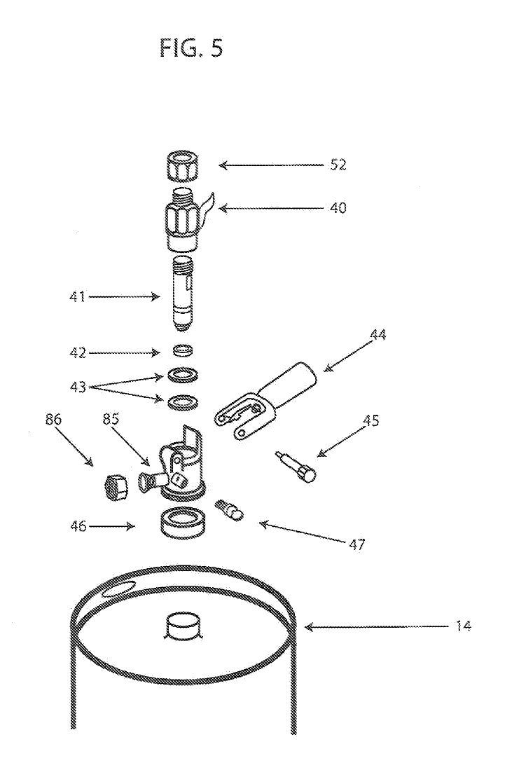

FIG. 5 shows retrofit of an industry standard lever coupler, including a probe 41, a seal 42, o-rings 43, a lever 44, a lever securing pin 45, a washer 46, a pressure relief valve 47, and the body of the coupler 48. Optionally, the pressure relief valve 47 may allow for manual or automatic pressure release valve to avoid over pressurizing the keg. The probe 41 does not have a back flow prevention device at the beer inlet/outlet side of the coupler, which is typically found in a standard lever coupler for kegs 14. Further the retrofit has a gas inlet valve 85 which is capped with a cap 86 and a shut off valve 40 attached to the probe 41. Optionally, a connector containing a screen or filter assembly 52 may be placed between shut off valve 40 and beer line 22 shown in FIG. 1.

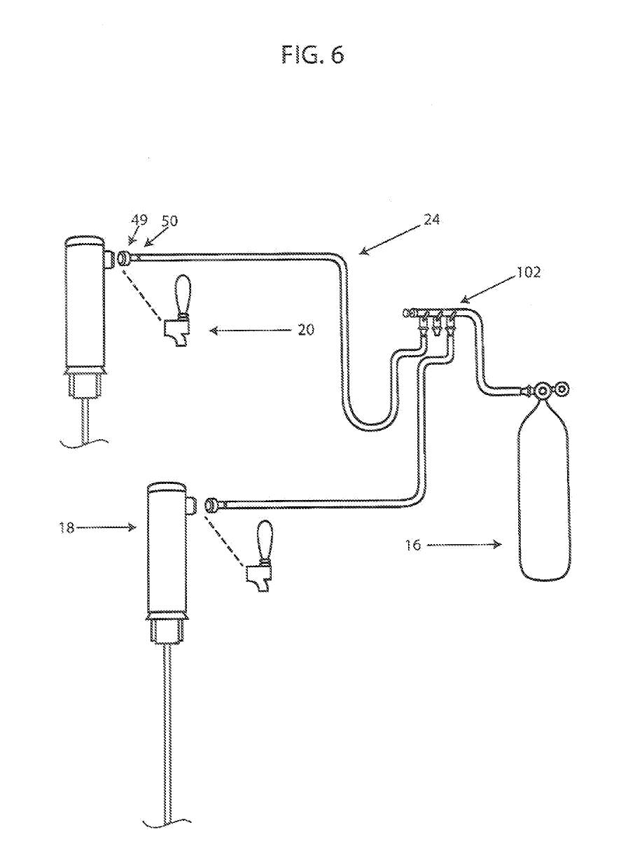

FIG. 6 shows a multi-port embodiment which allows the operator to recover beer from multiple lines more efficiently. There is a multi-port gas distribution manifold 102, attached to the gas tank 16 on the inlet, and multiple gas hoses 24. The gas hoses 24 are then attached via the clamped 50 faucet coupler ends 49 to the draft towers 18, after the existing faucet 20 has been removed. Optionally, the faucet coupler 49 may be a quick connect coupler instead of a screw connect coupler.

In using the embodiments shown in FIG. 1, FIG. 2, FIG. 3, and FIG. 5, to return beer to the keg 14 before cleaning the lines, the beer line 22 to be drained is removed from the establishment's existing coupler 12 and optionally may be clamped if beer is dripping. In practice it may not be necessary to clamp the beer line 22 because little beer drains from the beer line 22 in the short time it takes to transfer the beer line 22 from one coupler to another. The beer line 22 is then attached to the inventive lever coupler 10. The shut off valve 40 is in the off position. Optionally, a connector containing a screen or filter assembly 52 may be placed between shut off valve 40 and beer line 22 shown in FIG. 1. The existing coupler 12 on the beer keg 14 is then uncoupled and removed. The inventive lever coupler 10 is then attached to the beer keg 14. The beer line 22 is then unclamped if needed. The existing faucet 20 is removed from draft tower 18 and faucet coupler 49 is attached. Optionally, the faucet coupler 49 may be a quick connect coupler instead of a screw connect coupler. The gas line 51 is attached to the gas tank 16. The pressure of the gas from tank 16 is adjusted so that it does not to exceed the head pressure on the beer keg 14. A small amount of pressure is drained from the beer keg using the pressure relief valve 47. Optionally, the pressure relief valve 47 may allow for manual or automatic pressure release valve to avoid over pressurizing the keg. The straight shut off valve 40 is then opened and the higher gas pressure from the gas tank 16 pushes the recoverable beer backwards through the line and into the beer keg 14. As the beer flows back, more pressure may be released from the beer keg 14 as needed using the pressure relief valve 47. Once the beer in the existing beer line 22 has flowed back into the beer keg 14, the straight shut off valve 40 is closed. The gas is shut off, and the beer line 22 is removed from the inventive lever coupler 10. The inventive lever coupler 10 is then replaced with the establishment's standard lever coupler 12. The beer line 22 is now cleaned in the industry standard manner.

In the multi-port embodiment shown in FIG. 6 the procedure described above for the mono-port embodiment is repeated for each port of the multi-port design utilizing a plurality of gas lines 51 attached to a multi-port gas manifold 102 allowing the operator to recover beer from several beer lines 22 at the same time.

The advantages of the invention, without limitation, allow the establishment owners to recover otherwise wasted product during the standard draft line cleaning process. The standard process typically involves opening the tap in the bar and dumping all of the beer in the lines into buckets to be disposed of. The present invention recaptures the beer and saves it safely in the beer keg until the line cleaning process is completed. Once the lines are cleaned the beer is reintroduced into the lines using standard beverage dispensing methods. Further, the advantages are that the owner of the establishment can now sell the recovered product versus realizing revenue loss.

Many embodiments of this invention will occur to those skilled in the art. One embodiment includes removing the beer into a second set of lines, completing the line cleaning in the industry standard way and then reintroducing the beer into the original lines. Another embodiment includes using various styled couplers specific to various countries, referring specifically to the inlet/outlet port on the coupler body 48 for attachment to various types of beer kegs 14. Another embodiment includes having the establishment replace their standard lever coupler 12 with a different design such as that found in FIG. 4, which allows for cleaning, recovery and dispensing. Another embodiment includes taking an industry standard lever coupler 12 and retrofitting it such as that found in FIG. 5. Another embodiment includes minor changes to the process outlined in this invention which account for establishments having keg-in-series dispensing or beer pumps for long distance dispensing. All such embodiments are intended to be within the scope and spirit of the invention.

Although some embodiments are shown to include certain features, the applicants specifically contemplate that any feature disclosed herein may be used together or in combination with any other feature on any embodiment of the invention.

While the foregoing written description of the invention enables one of ordinary skill to make and use what is considered presently to be the best mode thereof, those of ordinary skill will understand and appreciate the existence of embodiments, combinations, and equivalents of the specific embodiment, method, and examples herein. The invention should therefore not be limited by the above described embodiment, method, and examples, but by all embodiments and methods within the scope and spirit of the invention.

1. A beer recovery system comprising a gas tank, a gas line, a beer keg lever coupler having no back flow prevention device in the probe.

2. A beer recovery system according to claim 1, further comprising a gas inlet port on the faucet.

3. A beer recovery system according to claim 1 in the form of a lever coupler which may be permanently attached to the beer keg.

4. A beer recovery system according to claim 2 in the form of a lever coupler which may be permanently attached to the beer keg.

5. A beer recovery system according to claim 1, further comprising a multi-port gas manifold.

6. A beer recovery system according to claim 2, further comprising a multi-port gas manifold.

7. A beer recovery system according to claim 3, further comprising a multi-port gas manifold.

8. A beer recovery system according to claim 4, further comprising a multi-port gas manifold.

9. A beer recovery system according to claim 1 further comprising a screen assembly.

10. A beer recovery system according to claim 2 further comprising a screen assembly.

11. A beer recovery system according to claim 3 further comprising a screen assembly.

12. A beer recovery system according to claim 1 further comprising a filter assembly.

13. A beer recovery system according to claim 2 further comprising a filter assembly.

14. A beer recovery system according to claim 3 further comprising a filter assembly.

15. A beer recovery system according to claim 1 further comprising a pressure release valve.

16. A beer recovery system according to claim 2 further comprising a pressure release valve.

17. A beer recovery system according to claim 3 further comprising a pressure release valve.
